(19) United States
(12) Patent Application Publication
(10) Pub. No.: US 2014/0101259 A1
(43) Pub. Date: Apr. 10, 2014

(54) System and Method for Threat Assessment

(71) Applicant: OPERA SOLUTIONS, LLC, JERSEY CITY, NJ (US)

(72) Inventors: Nicholas Barone, East Norwich, NY (US); Brian Kolo, Lansdowne, VA (US); Aaron Winters, Fairfax, VA (US)

(73) Assignee: OPERA SOLUTIONS, LLC, JERSEY CITY, NJ (US)

(21) Appl. No.: 13/645,695

(22) Filed: Oct. 5, 2012

(51) Int. Cl. G06F 15/16

(52) U.S. Cl. 709/206

(57) ABSTRACT

A system and method for threat assessment are provided. The system includes a computer system; a data access subsystem programmed into and executed by the computer system for receiving data from a data source, and parsing the data to identify one or more messages; an analytics subsystem programmed into and executed by the computer system for processing and scoring the one or more messages to calculate one or more threat scores; and a communications subsystem programmed into and executed by the computer system for transmitting the one or more messages to a user.

### BACKGROUND OF THE INVENTION

1. Field of the Invention

The present invention relates generally to automatically assessing a threat using text data or other content. More specifically, the present invention relates to a system and method for threat assessment.

2. Related Art

The World Wide Web is used by millions, if not billions, of people on a daily basis. Many people throughout the world regularly post information on the internet in public or semi-public areas. Internet forums are a popular choice for many web users to post their thoughts and concerns. These public, semi-public, and private forums provide a large volume of regularly updated information accessible by computers.

Computers are growing in their capacity to process large volumes of information and provide analysis on such data. The combination of increasingly powerful computer systems with access to the large volume of information available on the Internet provides an opportunity for big data analytics systems to process large volumes of information on a regular basis, particularly for identifying threats and notifying users regarding same.

### SUMMARY OF THE INVENTION

The present invention relates to a system and method for threat assessment. In one embodiment, the invention provides a threat assessment system that includes a computer system; a data access subsystem programmed into and executed by the computer system for receiving data from a data source, and parsing the data to identify one or more messages; an analytics subsystem programmed into and executed by the computer system for processing and scoring the one or more messages to calculate one or more threat scores; and a communications subsystem programmed into and executed by the computer system for transmitting the one or more messages to a user.

In another embodiment, the present invention relates to a method for threat assessment. The method includes the steps of receiving data from a data source using a computer system; parsing the data to identify one or more messages using a data access subsystem programmed into and executed by the computer system; processing and scoring the one or more messages using an analytics subsystem to calculate one or more threat scores; and transmitting the one or more messages and the one or more threat scores to a user.

In another embodiment, the present invention relates to a computer-readable medium having computer-readable instructions stored thereon which, when executed by a computer system, cause the computer system to perform the steps of receiving data from a data source using a computer system; parsing the data to identify one or more messages using a data access subsystem programmed into and executed by the computer system; processing and scoring the one or more messages using an analytics subsystem to calculate one or more threat scores; and transmitting the one or more messages and the one or more threat scores to a user.

### BRIEF DESCRIPTION OF THE DRAWINGS

Features of the invention will be apparent from the following descriptions of the Invention, taken in connection with the accompanying drawings, in which:

FIG. 1 is a diagram illustrating the threat assessment system;

FIG. 2 is a diagram showing an example of a typical posting received by the data access subsystem of the threat assessment system;

FIG. 3 is a diagram showing an example of a multilingual single field of a message, and an example of multiple multilingual messages;

FIG. 4 is a flowchart showing processing steps carried out by the threat assessment system;

FIG. 5 is a screenshot showing a login screen generated by the administrator subsystem interface for authenticating a username and password;

FIG. 6 is a screenshot of an administration console generated by the administrator subsystem interface for configuring user settings;

FIG. 7 is another screenshot of the administration console for configuring administrative settings;

FIG. 8 is a diagram illustrating computation by the threat assessment system of a threat score for a message;

FIG. 9 is a diagram illustrating a termlist generated by the system with a set of terms and an associated numeric score for each term; and

FIG. 10 is a diagram showing hardware and software components of a computer system capable of performing the processes of the present invention.

### DETAILED DESCRIPTION OF THE INVENTION

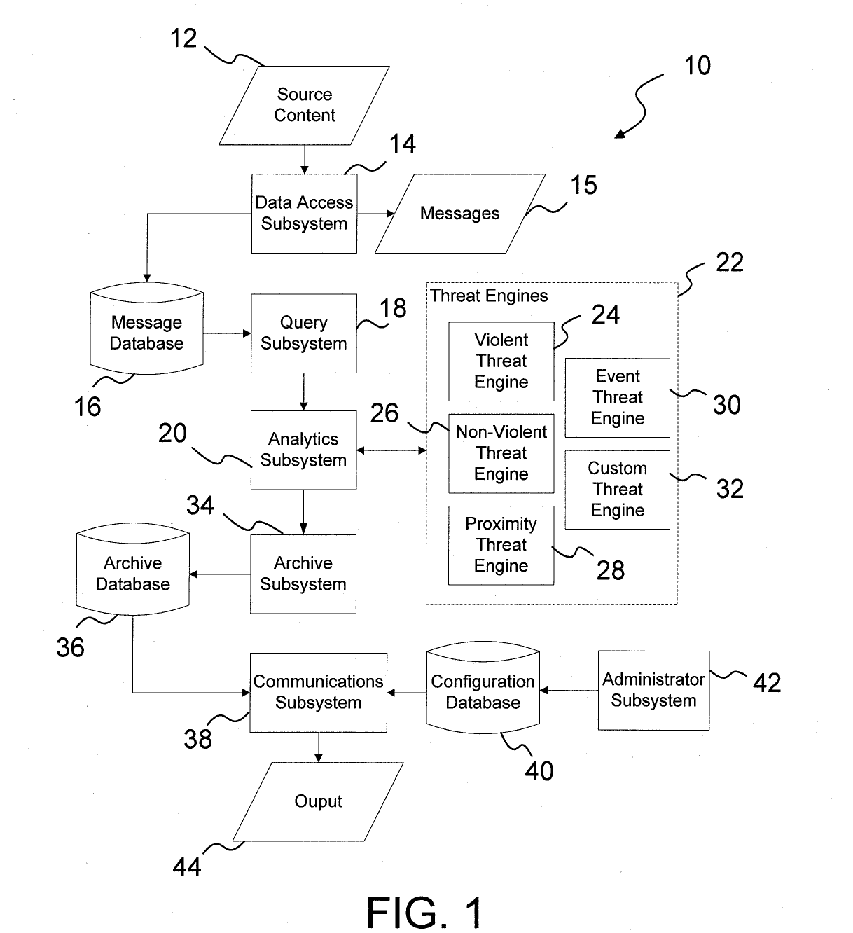

The present invention relates to a system and method for threat assessment, as discussed in detail below in connection with FIGS. 1-10.

FIG. 1 is a diagram illustrating a threat assessment system 10 of the present invention. An important feature of the threat assessment system is that it is capable of operating 24 hours a day, 7 days a week. This allows threats to be analyzed and identified in real time and reported to users for action. Such a system is capable of identifying actionable intelligence to support security personnel, as well as law enforcement personnel.

The data access subsystem 14 receives or downloads source content 12 (e.g., data, text data, documents, etc.) from one or more data sources (e.g., the Internet). The data sources could include web pages, forums, chat groups, comment areas, etc., and could contain information in multiple languages. The data access subsystem 14 parses/processes the received data 12 (e.g., posting on a website), and identifies messages/records 15. Messages 15 could be found in any form and processed, with or without using the Internet. The source content could be in any suitable computer readable format (e.g., text file, Microsoft Word, Adobe Acrobat, Microsoft Office product, etc.). The messages 15 are then stored in one or more message databases 16 (i.e., record databases), where the message database 16 is typically a relational database that can by queried using Structured Query Language (SQL). However, other database constructs could be used, such as object oriented databases, flat file database, or XML files.

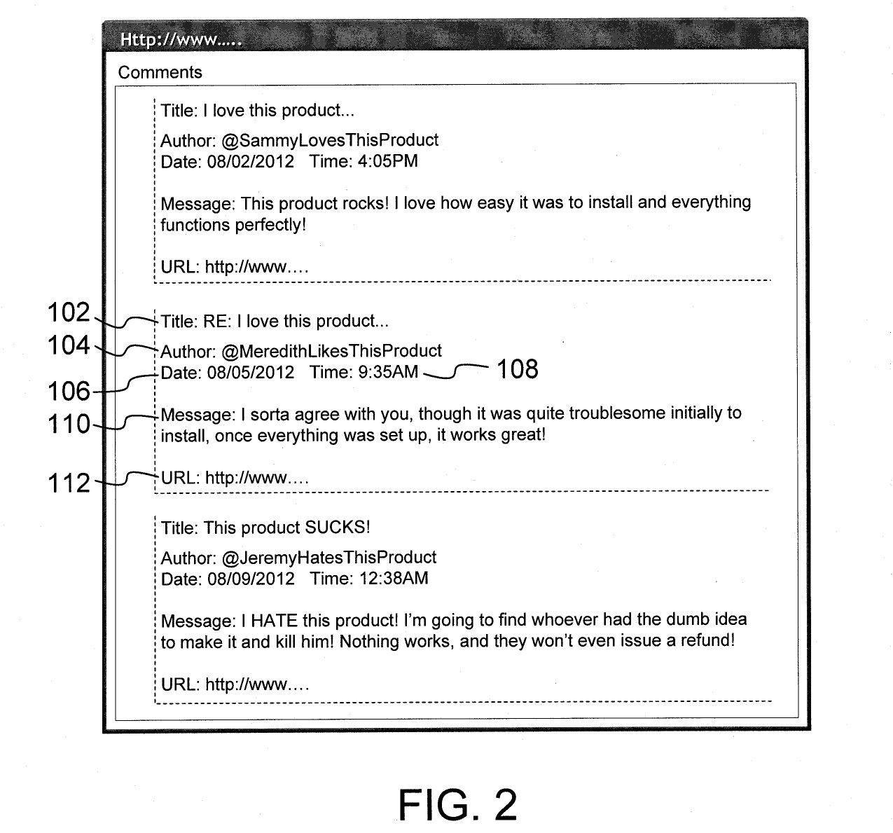

Source content 12 (e.g., forums, chat groups, and/or comment areas) have several fields that could be identified by the data access subsystem 14 and used to create a record of the message 15. In this way a typical message 15 recorded in the message database 16 could contain the author, title, date, time, URL, text content, etc. The listed author, date, time, and title of the message could be specified, or inferred from the context of the message, and is often found in forum posts, chat room posts, comment area of a message board, etc. FIG. 2 is a diagram showing an example of a typical posting received by the data access subsystem 14 and containing a title 102, author 104, date 106, time 108, text of the message 110, and URL 112. The URL could be the actual URL (i.e., where the data access subsystem obtained the message), or it could be a related URL. For example, sometimes a forum may repost a message from another forum. In such a case the data access subsystem could choose to use the URL where the message was obtained, or it could choose to use the original URL.

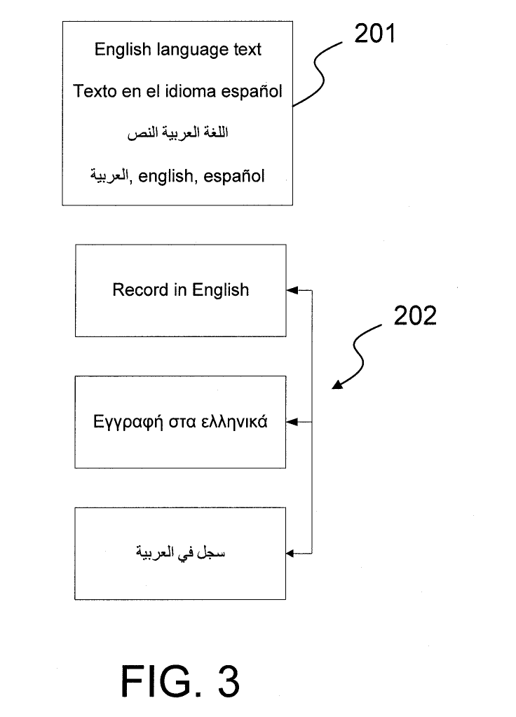

Text based fields of a message (e.g., title, URL, and the text content) could contain information in multiple languages. FIG. 3 is a diagram showing an example of a multilingual single field 201 of a message, and an example of multiple multilingual messages 202 with each message containing a different language. A single field 201, such as text content, could contain multiple languages within the field. Also, the text field of one message could be in one language and the text field of another message in a second language, so that there are different languages across multiple fields. Additionally, there could be a combination of these two scenarios.

The query subsystem 18 queries/accesses the message database 16 to identify messages matching a set of search criteria. Queries could be generated by the user and/or the threat assessment system. A query, or query limitation, is a request for database records that match one or more criteria, or in other words, is a means to search a database. Queries are typically programmed using the SQL language and are not in plaintext form, although any programming language capable of retrieving information from a database could be used. Generally, any field in the message database is a potential for a query or a query limitation. A query could be an exact match (e.g., ‘find all messages where the author's name is Brian’), could be a range (e.g., ‘find all messages where the date is earlier than 05/22/1972 and later than 08/01/1941’), or could be a limitation (e.g., ‘find all records where the author's name starts with the letter B’). Queries could contain several different fields or field limitations, and the variety of the constraints could depend on the fields available in the message database 16. For example, a query could request records containing one or more specified terms in the text content, terms in the title, a specified date range, a specified time range, one or more authors, and/or one or more URLs.

Any messages identified and obtained by the query subsystem 18 are then sent to the analytics subsystem 20. The analytics subsystem 20 processes each message 15 identified by the query subsystem 18 and has each threat engine 22 independently calculate a threat score for each message 15 for a particular situation (i.e., produce one or more values), although the threat scores could also be calculated into a single score. The threat engines 22 utilized by the analytics subsystem are discussed in more detail below, and could include the violent threat engine 24, non-violent threat engine 26, proximity threat engine 28, event threat engine 30, and custom threat engine 32, among others. The calculated scores could be used to identify messages 15 that are hits, where a hit is a message 15 that has one or more scores that fall within a specified predefined range, or hit threshold (e.g., message is a hit if the message is scored as a 7 and the threshold is a 5). In this way, a series of thresholds could be used to compute hits on a numerical range. For example, messages that score under a 3 are considered low, scores from 3 to 5 are medium, and scores above 5 are high. In such a case, each message 15 is categorized as low, medium, or high depending on the message score. Alternatively, the score could have multiple components, such as where a score has an x and y value, with the x and y values having different thresholds. For example, thresholds for x could be set at <3, 3-5, and >5, and for y set at <10, 10-50, and >50. These thresholds are independent and a message 15 could be scored as the x-y combinations of low-low, low-medium, low-high, medium-low, medium-medium, medium-high, high-low, high-medium, and high-high. Moreover, a multiscore metric dependent on one or more threshold combinations could be used to identify a hit, such as where:

Equations 1-3

x²+y²≦r₁² (1)

r₁²<x²+y²≦r₂² (2)

x²+y²>r₂² (3)

It should be appreciated that messages 15 could be scored in series or in parallel with other messages 15. Each message 15 could be processed by the engines 22 in sequence wherein one message 15 is completely scored by all of the engines 22 before the next message is considered. Alternatively, messages 15 could be processed in parallel wherein multiple messages 15 are simultaneously processed in parallel with other messages 15. Moreover, messages 15 could be processed in any order and in any combination of series and/or parallel. Similarly, it should also be appreciated that the threat engines 22 could work in series or in parallel with each other. The engines 22 could run sequentially wherein a score is computed for a message 15 by each engine one at a time. Alternatively, a message could be simultaneously processed in parallel by multiple engines 22. Moreover, these engines 22 could run in any order and in any combination of series and/or parallel.

The archive subsystem 34 then processes each scored message 15 and stores the scored message in the archive database 36 along with the corresponding score or sets of scores (i.e., score of each threat engine) associated with the message 15. Other information relating to the message could be stored in the archive database 36 as well, such as the date and time of retrieval, the source of the message (e.g., a URL), etc.

Then the communications subsystem 38 identifies and communicates any hits to one or more users and/or to one or more computer systems for further processing. The communications subsystem 38 retrieves messages 36 from the archive database 36 to identify hits (i.e., messages that have one or more scores within a hit threshold) to send to users. The communications subsystem 38 then uses a configuration database 40, which stores information on the users of the system, to determine which users should be notified about which hits. The configuration database 40 is managed and updated through the administrator subsystem 42, described in more detail below. The administrator subsystem 42 allows a user to configure and store individual or group settings for a user or group of users (e.g., add a new user, remove an existing user, reset a password, change password, etc.), and then stores the configured information in the configuration database 40. In the configuration database 40, each user is associated with one or more communications means, and through the administrator subsystem 42 each user can specify which engines to receive hits from, and specify the severity levels (e.g., low, medium, high) they want to receive. The communications subsystem 38 uses the information stored in the configuration database 40 to prepare messages based on the user-specified configuration. In other words, the communications subsystem 38 uses the information to determine which hits need to be sent to which users. The communications subsystem 38 could utilize any suitable method for message delivery (e.g., email, text message, page, generating a webpage, producing the output on a list on a computer screen, fax, etc.).

The communications subsystem 38 then sends the one or more hits as output 44 to the proper users, and/or to other computer systems for further processing. Multilingual messages outputted to users could be handled in two different ways. First, the communications subsystem could simply send a multilingual message 15 just as any ordinary message 15. Alternatively, the communications subsystem could incorporate a machine translating subsystem for translating a multilingual message 15 into a desired target language and outputting the message 15 in the desired language. The configuration database could contain a desired target language unique to each user.

It should also be appreciated that the hardware configurations for the threat assessment system could be varied in many ways. For example, the message database, archive database, and configuration database could be located on separate servers, or all three could be in different databases on a single server. Furthermore, these databases could be combined into a single database on a single server, or could be a single database distributed across a server cluster.

It should be appreciated that the components of the threat assessment system could be varied to create different versions of the threat assessment system, and that not all of the components need to be included. The various subsystems and engines work together in a coordinated manner to process a message through the system. This coordination could be achieved in a single system by sequentially processing each message through each system in series or messages could be processed in batch form through the system. In one embodiment, each of the systems work independently of each other and monitor a database, file directory, and/or message queue to determine when and what to process. This enables the systems to operate autonomously and potentially in parallel across multiple servers to efficiently process messages through the system. An example of such an embodiment is where the data access subsystem identifies new messages and puts a batch of messages into the message database. The query subsystem runs independently and regularly queries the message database for new messages, and then sends any new messages to the analytics subsystem for scoring. The analytics subsystem scores each message with each of the threat engines. The messages and their corresponding scores are written to a file directory. The archive subsystem regularly monitors the directory and when new files are present, the archive system processes each file by opening the file, reading the content, storing the content into an archive database, and then deleting the original files from the file directory. The communications subsystem regularly monitors the archive database for new messages. When a new record is present, the communications subsystem processes the new messages by identifying the hit level (e.g., low, medium, high) and sends them to users (and/or other computer systems) based on the user configuration information stored in the configuration database.

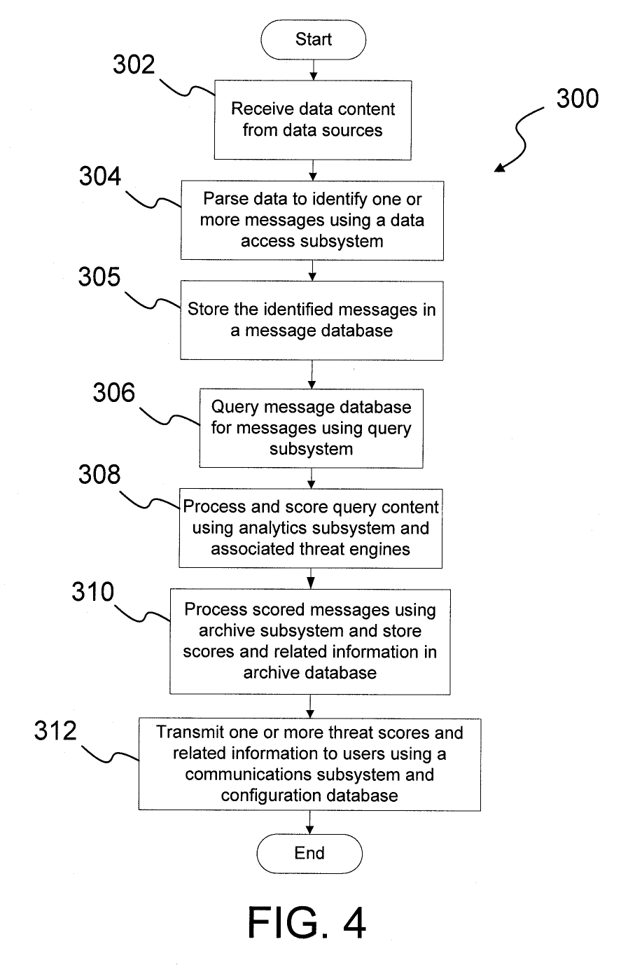

FIG. 4 is a flowchart 300 showing processing steps carried out by the threat assessment system. Starting in step 302, data content is received from one or more data sources. In step 304, the data is parsed to identify one or more messages using a data access subsystem. In step 305, the identified one or more messages are stored in a message database. In step 306, the message database is queried using the query subsystem to identify one or more messages from the message database, and in step 308, the one or more messages identified by the query subsystem are processed and scored using an analytics subsystem and associated threat engines to calculate one or more threat scores. In step 310, the messages are processed using an archive subsystem and then the one or more messages, one or more scores, and related information are stored in an archive database. In step 312, the one or more messages and one or more threat scores are transmitted to a user using the communications subsystem and configuration database.

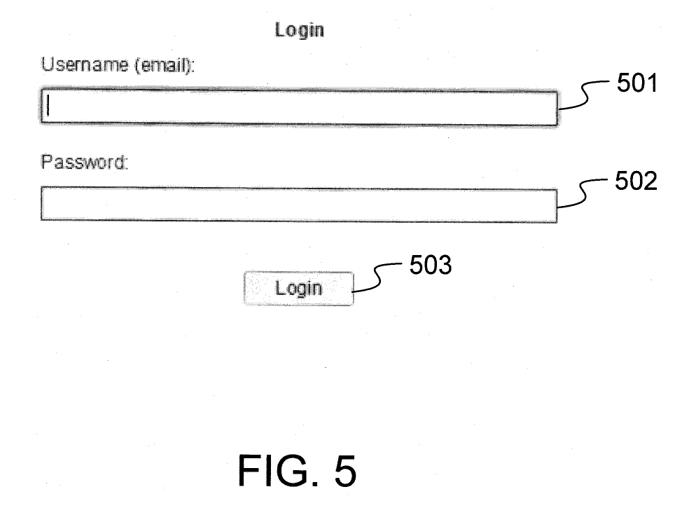

FIG. 5 is a screenshot showing a login screen generated by an administrator subsystem interface for authenticating a username 501 and password 502. The login button 503 provides a means to authenticate a user's security credentials and gain access to the system. The administrator subsystem could store one or more validation procedures in the configuration database for a user or group of users to authenticate prior to allowing changes to settings (e.g., username and password).

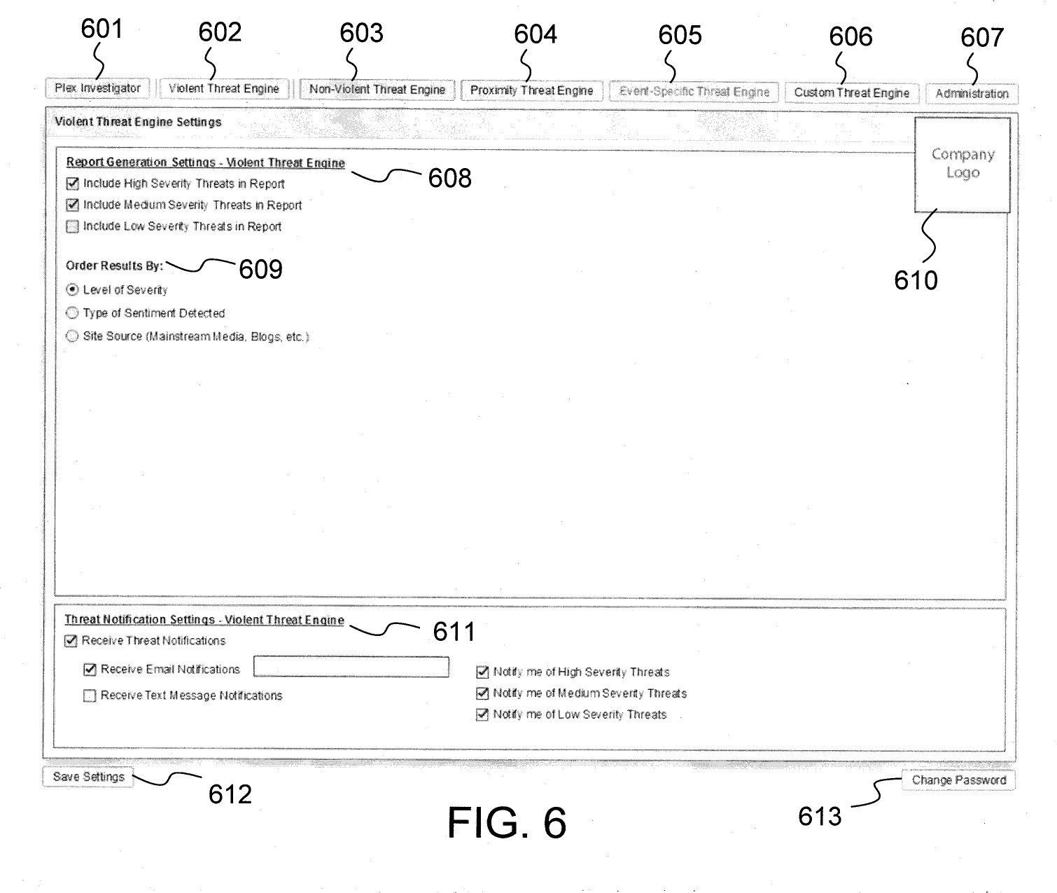

FIG. 6 is a screenshot of an administration console generated by the administrator subsystem interface for configuring user settings. The plex investigator tab 601 provides the ability for a user to ad-hoc search. The administrator subsystem provides the user with the ability to change settings for each threat engine with regards to which engines they would like reported (e.g., violent, non-violent, proximity, event, custom) as well as what level of severity they would like reported for each engine (e.g., low, medium, high). There are tabs for each of the different threat engines to allow the user to configure settings for the violent threat engine 602, non-violent threat engine 603, proximity threat engine 604, event-specific threat engine 605, and custom threat engine 607. There is also an administrator tab 607 to allow the user to complete general administrative tasks, discussed in more detail below. The administrator subsystem could also have a company logo 610 unique to the user that accesses the console.

Under each tab for the threat engines, there is the ability to specify what level of severity of threats the user wants reported 608. In this example, the user has specified he/she would like to receive high and medium, but not low, severity threats for the violent threat engine. The administrator subsystem also provides for the user to specify how he/she would like the reported hits to be organized for display 609, such as by level of severity, type of sentiment detected, or by the data source the message was collected. In this example, the user has specified that he/she would like to have the hits ordered by the level of severity.

The user could specify how he/she would like to receive the reported hits 611. The administrator subsystem could provide the means by which the hits are reported to a user or group of users, such as via text messaging, email, etc. The administrator subsystem collects the necessary information (e.g., phone number, email address, etc.) and stores that information in the configuration database to be subsequently used by the communications subsystem for final reporting to users. In this example the user has specified that he/she would like to receive the reported hits via email, but the user could also specify to receive hits via text message. Once the user has configured the settings, he/she can save their settings 612 to the configuration database. The user at any time can specify that he/she wants to change their password to access their settings in the administrator subsystem 613.

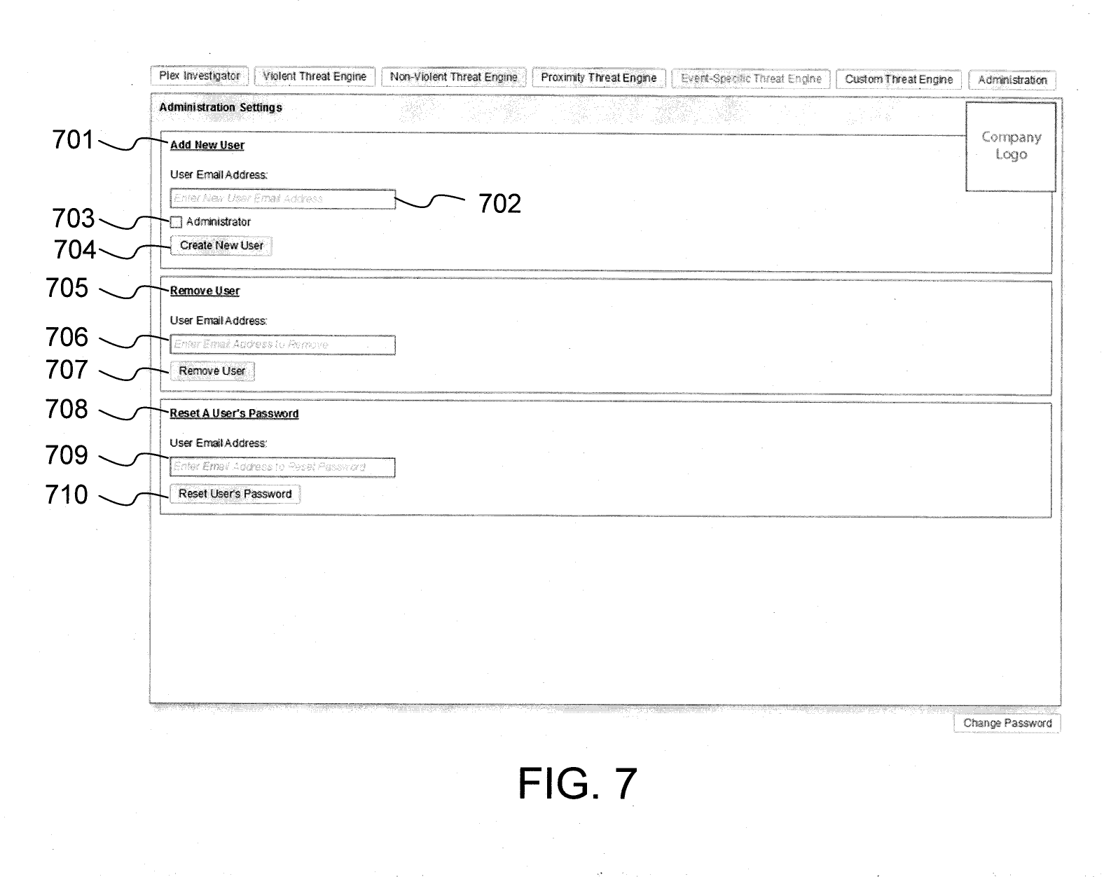

FIG. 7 is another screenshot of the administration console for configuring administrative settings. Administrators could have the ability to create new user accounts 701 by specifying a new user's credentials (e.g., email address 702), as well as specifying whether the new account has administrator rights 703. Once the parameters for creating a new user have been specified, the administrator can finalize the creation via clicking the “Create New User” button 704. Administrators could also have the ability to remove existing user accounts 705. In this example, the administrator specifies the email address of the account they want to remove 706. Upon specifying the account, the administrator can finalize the removal via clicking the Remove User” button 707. Administrators could also have the ability to reset an existing user's password 708. In this example, the administrator specifies the email address of the account they want to reset the password 709. Upon specifying the account they want to reset the password, the user can finalize the resetting via clicking the “Reset User's Password” button 710.

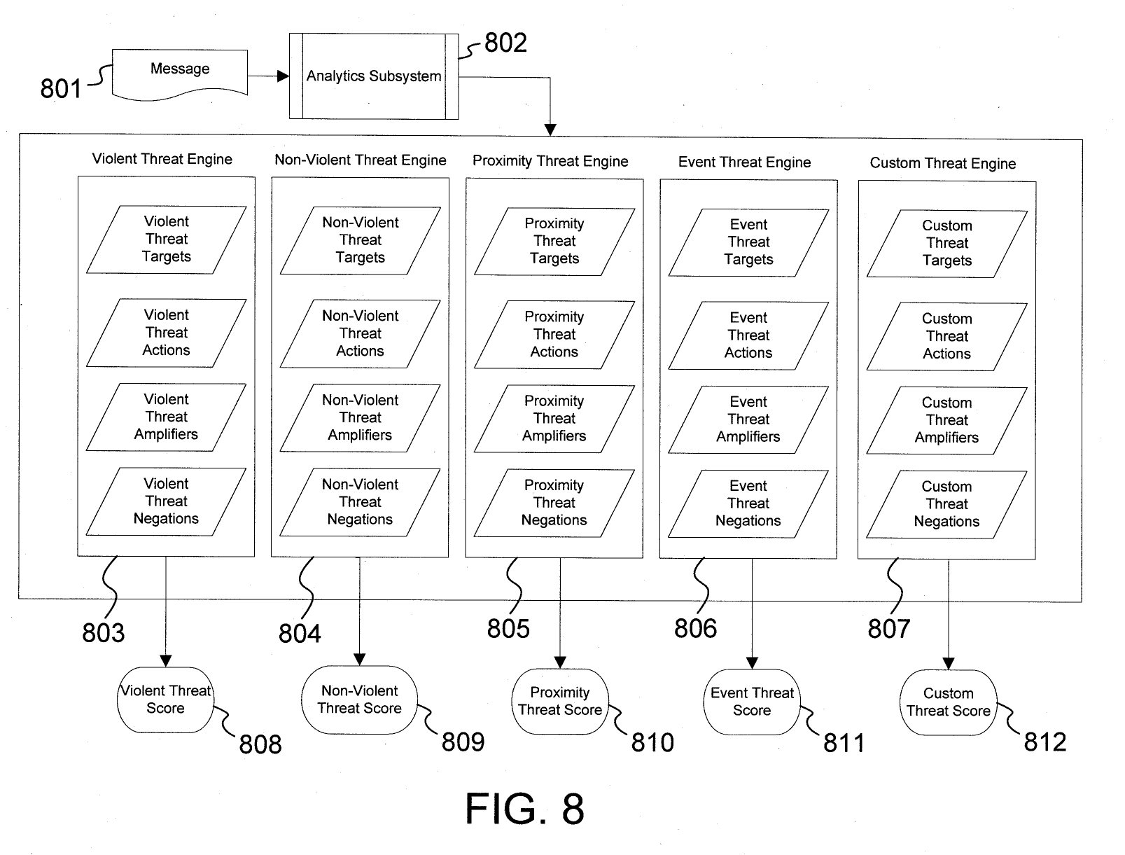

FIG. 8 is a diagram illustrating computation by the threat assessment threat score for a message. As explained above, one or more messages 801 are processed by the analytics subsystem 802. The analytics subsystem 802 is comprised of a set of engines, such as a violent threat engine 803, non-violent threat engine 804, proximity threat engine 805, event threat engine 806, and custom threat engine 807. Each of these engines uses termlists for targets, actions, amplifiers, and negations. Each produces a separate score resulting in a violent threat score 808, non-violent threat score 809, proximity threat score 810, event threat score 811, and custom threat score 812.

The violent threat engine 803 computes a score for a message indicating the propensity of the message content toward violent threats, which may be indicated by words such as kill, harm, hit, strike, etc. The non-violent threat engine 804 computes a score for a message indicating the propensity of the message content toward non-violent threats, which may be indicated by words such as protest, strike, boycott, etc. Violent and non-violent threats could be targeted against a person, group, property, location, etc. The proximity threat engine 805 computes a score for a message indicating the propensity of the message content toward threats that are not directly against a target. Proximity threats could be against a person, group, property, location, etc. that is determined to be in the vicinity of, but does not directly threaten, a target of interest, and may be indicated by words such as kill, harm, protest, boycott, etc. The proximity engine examines a message to determine if the threat is in proximity to one or more of the targets. The event threat engine 806 computes a score for a message indicating the propensity of the message content toward an event of interest. Event threats are related to a specific event and may be against a person, group, property, location, etc., and may be indicated with words such as kill, harm, hit, boycott, protest, etc. The custom threat engine 807 computes a score for a message indicating the propensity of the message content toward threats customized by a user. The custom threat engine could overlap with any or all of the other engines, and could have a target list and/or an action list customizable by a user.

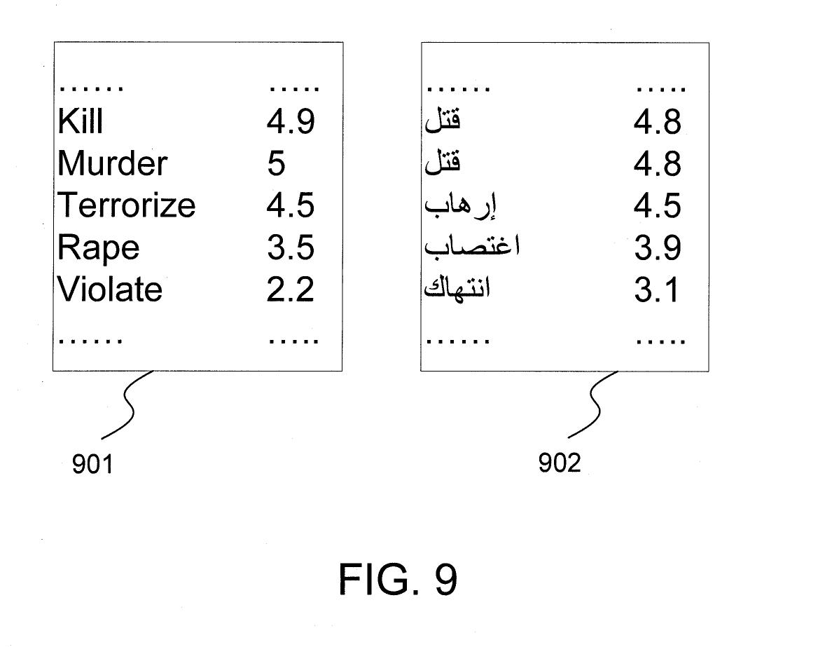

Two methods, of many, that could be used for scoring messages are statistical language processing and natural language processing, which could be used alternatively or in combination. Statistical Language Processing (SLP) parses a message into a sequence of words or phrases and matches one or more wordlists or termlists. A wordlist is a list of words with each matched to a score value. A termlist is a list of words or phrases with each matched to a score value. A termlist is more general than a wordlist, and a wordlist could be considered a special case of a termlist. Similarly, a term is a generalization of a word, and a word could be considered a term. FIG. 9 is a diagram illustrating a termlist 901 generated by the system with a set of terms and an associated numeric score for each term. As shown, termlists could be also be in another language 902 (e.g., Arabic) besides English.

The analytics subsystem uses one or more termlists to determine the score for a message. Termlists are created for each engine for Targets, Actions, Amplifiers, and Negations, where each engine varies in the content and scoring of the termlists. In a preferred embodiment, the violent threat engine, non-violent threat engine, proximity threat engine, and event threat engine each include the termlists Targets, Amplifiers, and Negations. The violent engine and non-violent engine additionally include, respectively, the termlist Violent Actions and Non-Violent Actions. The proximity engine and event engine each additionally include the termlist All Actions, which combines the termlists for Violent Actions and Non-Violent Actions. The custom engine allows each of the termlists to be specified by a user (e.g., termlists for Custom Targets, Custom Actions, Custom Amplifiers, and Custom Negations).

It should be appreciated that the termlists used by the engines are not limited to just Violent, Non-Violent, Proximity, Event and Custom termlists. The mechanics of the engines only require a termlist comprising a list of terms and an associated weight/score for each term. An engine could use termlists such as Actors and Actions whereby the engines match specific actions to actions rather than matching targets to threats. There are many possible variants for termlists that could be used to create engines that identify hits other than threats.

An SLP engine examines a message and identifies each term in the message that matches a term in one or more, but preferably all, of the termlists (e.g., Targets termlist, Actions termlist, Amplifiers termlist, Negations termlist). For each matched term, the location of the term in the message is recorded. This could be accomplished by numbering the words and associating the count of the word at the beginning of a term, or it could be accomplished by numbering each character and associating the count of the character that appears at the beginning of the term. It should be noted that if a term is present in the message multiple times, there will be multiple entries for that term on the list, one for each unique incidence of the term.

Each message is decomposed into a list of Targets, Actions, Amplifiers, and Negations. Each list has a term from the corresponding termlist and the position the term appears in the message (e.g., by word or character count). The elements in the Target list are paired with the elements in the Actions list to create a Targets-Actions cross product list. If there are T entries on the Targets list and A entries on the Actions list, the Targets-Actions cross product list will have T·A entries. For each of these entries a score is computed based on the position of the corresponding terms in the Targets and Actions list. For example, a simple scoring method could be:

$${S}_{n} = \{ \begin{matrix}1 & \vert {T}_{n} ( Position ) - {A}_{n} ( Position ) \vert < threshold \\ 0 & otherwise\end{matrix} \qquad Equation 4$$

Tₙ(Position) is the position of the Threat term in the list while Aₙ(Position) is the position of the Action term in the list. This scoring metric returns the value 1 when the Target and Action terms are within threshold units of each other and returns 0 otherwise. This metric identifies Target-Action pairs that are in some sense close to each other in the message.

More general scoring methods might include a function of the Target and Action term positions such as:

Equation 5

Wₙ=f(Tₙ(Position),Aₙ(Position),Tₙ(Weight),Aₙ(Weight))

Here, f(x,y,a,b) is some function relating these four values together. In this expression, Tₙ(Weight) is the weight of the term in the Targets termlist while Aₙ(Weight) is the weight of the term in the Actions termlist.

The message score could be computed using a mathematical formula such as:

$${S}_{n} = {\sum }_{{c}_{i} ∈ T \cdot A} {W}_{i} \cdot {M}_{i} \cdot {N}_{i} \qquad Equation 6$$

In this formula, cᵢ is the i^{th} term from the Targets-Actions cross product list, Wᵢ is the weight associated with this term as computed above, Mᵢ is the weight from the Amplifiers list, and Nᵢ is the weight from the Negations list. Mᵢ and Nᵢ are computed by identifying terms on the Amplifiers and Negations lists that are in proximity to the items in cᵢ. Again, these could be computed using a simple distance-threshold metric, or could be computed using more general functions of the variables.

The SLP engines could handle multilingual messages in two different ways. First, each of the termlists could simply contain terms and weights/scores for a variety of languages. Second, each message could be translated into the language used in the termlists and then the message processed through the engines as usual.

Natural Language Processing (NLP) examines the content of a message and parses it to attempt to have a computer understand the content (as explained in Natural Language Processing, Wikipedia, http://en.wikipedia.org/wiki/Natural_language_processing, the entirety of which is incorporated herein by reference). NLP typically uses a set of components to break apart a message into easily digestible pieces. An NLP engine could include one or more of a number of functions/tasks. Such functions/tasks could include, Automatic Summarization, Coreference Resolution, Discourse Analysis, Machine Translation, Morphological Segmentation, Named Entity Recognition (NER), Natural Language Generation, Natural Language Understanding, Optical Character Recognition (OCR), Part-of-Speech Tagging, Parsing, Question Answering, Relationship Extraction, Sentence Breaking, Sentiment Analysis, Speech Recognition, Speech Segmentation, Topic Segmentation and Recognition, Word Segmentation, Word Sense Disambiguation.

Automatic Summarization produces a readable summary of a portion of text, and is often used to provide summaries of text of a known type (e.g., articles in the financial section of a newspaper). Coreference Resolution determines which words refer to the same objects or entities when given a sentence or larger portion of text. Anaphora resolution is a specific example of this task, and is specifically concerned with matching up pronouns with the nouns or names to which they refer. For example, in the sentence “He entered John's house through the front door,” “the front door” is a referring expression and the bridging relationship to be identified is the fact that the door is the front door of John's house, rather than of some other structure that might also be referred. Discourse Analysis is a rubric that includes a number of related tasks. One such task is identifying the discourse structure of connected text, i.e., the nature of the discourse relationships between sentences (e.g. elaboration, explanation, contrast). Another possible task is recognizing and classifying the speech acts in a portion of text (e.g. yes-no question, content question, statement, assertion, etc.). Machine Translation automatically translates text from one human language to another. This is a difficult problem, and is a member of a class of problems colloquially termed “AI-complete,” i.e., requiring all of the different types of knowledge that humans possess (e.g., grammar, semantics, facts about the real world, etc.) in order to solve properly.

Morphological Segmentation separates words into individual morphemes and identifies the class of the morphemes. The difficulty of this task depends greatly on the complexity of the morphology (i.e. the structure of words) of the language being considered. English has fairly simple morphology, especially inflectional morphology, and thus it is often possible to ignore this task entirely and simply model all possible forms of a word (e.g. open, opens, opened, opening) as separate words. In some languages (e.g., Turkish), however, such an approach is not possible, as each dictionary entry has thousands of possible word forms. Named Entity Recognition (NER) determines, when given a stream of text, which items in the text map to proper names (e.g., people or places), and the type of each such name (e.g. person, location, organization). Although capitalization can aid in recognizing named entities in languages such as English, this information cannot aid in determining the type of named entity, and in any case is often inaccurate or insufficient. For example, the first word of a sentence is capitalized, and named entities often span several words, only some of which are capitalized. Furthermore, many other languages in non-Western scripts (e.g., Chinese, Arabic, etc.) do not have any capitalization at all, and even languages with capitalization may not consistently use it to distinguish names. For example, German capitalizes all nouns, regardless of whether they refer to names, and French and Spanish do not capitalize names that serve as adjectives.

Natural Language Generation converts information from computer databases into readable human language. Natural Language Understanding converts portions of text into more formal representations such as first-order logic structures that are easier for computer programs to manipulate. Natural language understanding involves the identification of the intended semantic from the multiple possible semantics which could be derived from a natural language expression which usually takes the form of organized notations of natural languages concepts. Introduction and creation of language metamodel and ontology are efficient but empirical solutions. An explicit formalization of natural language semantics without confusions and with implicit assumptions (e.g., closed world assumption (CWA) vs. open world assumption, subjective Yes/No vs. objective True/False) is expected for the construction of a basis of semantics formalization. Optical Character Recognition (OCR) determines the corresponding text when given an image representing printed text.

Part-of-Speech Tagging determines the part of speech for each word when given a sentence. Many words, especially common ones, can serve as multiple parts of speech. For example, “book” can be a noun (“the book on the table”) or verb (“to book a flight”), “set” can be a noun, verb or adjective, and “out” can be any of at least five different parts of speech. Note that some languages have more ambiguity than others. Languages with little inflectional morphology, such as English are particularly prone to such ambiguity. Chinese is prone to such ambiguity because it is a tonal language during verbalization. Such inflection is not readily conveyed via the entities employed within the orthography to convey intended meaning. Parsing determines the parse tree (grammatical analysis) of a given sentence. The grammar for natural languages is ambiguous and typical sentences have multiple possible analyses. In fact, perhaps surprisingly, for a typical sentence there may be thousands of potential parses, most of which will seem completely nonsensical to a human.

Question Answering determines an answer when given a human-language question. Typical questions have a specific right answer (e.g., “What is the capital of Canada?”), but sometimes open-ended questions are also considered (e.g., “What is the meaning of life?”). Relationship Extraction identifies the relationships among named entities when given a portion of text (e.g. who is the wife of whom). Sentence Breaking finds the sentence boundaries when given a portion of text. Sentence boundaries are often marked by periods or other punctuation marks, but these same characters can serve other purposes (e.g. marking abbreviations). Sentiment Analysis extracts subjective information usually from a set of documents, often using online reviews to determine “polarity” about specific objects. It is especially useful for identifying trends of public opinion in the social media for the purpose of marketing. Speech Recognition determines the textual representation of the speech when given a sound clip of a person or people speaking. This is the opposite of text to speech and is an “AI-complete” problem. In natural speech there are hardly any pauses between successive words, and thus speech segmentation is a necessary subtask of speech recognition. Note also that in most spoken languages, the sounds representing successive letters blend into each other in a process termed coarticulation, so the conversion of the analog signal to discrete characters can be a very difficult process.

Speech Segmentation separates a sound clip of a person or people speaking into words. This is a subtask of speech recognition and typically grouped with it. Topic Segmentation and Recognition separates a portion of text into segments, each of which is devoted to a topic, and identifies the topic of the segment. Word Segmentation separates a chunk of continuous text into separate words. For a language like English, this is fairly trivial, since words are usually separated by spaces. However, some written languages like Chinese, Japanese, and That do not mark word boundaries in such a fashion, and in those languages text segmentation is a significant task requiring knowledge of the vocabulary and morphology of words in the language. Word Sense Disambiguation selects the meaning which makes the most sense in context when a word has more than one meaning. For this problem, typically a list of words and associated word senses is given, such as from a dictionary or from an online resource (e.g., WordNet).

SLP and NLP systems could be combined together, using any of a wide-variety of methods. For example, an SLP system could be augmented by an NLP system by having the NLP system parse and portion the message, then match the portions to elements on the termlist. Alternatively, an NLP engine could be augmented with an SLP engine by first processing messages with SLP and then further processing high-scoring messages with NLP to gain additional refinement.

The system could be configured to include machine learning algorithms to create an adaptive threat assessment subsystem. For example, a feedback system could be incorporated that allows a user to state if the score for a hit presented to a user was correct, high, or low. An adaptive subsystem, or adjustment subsystem, collects and records this information and adjusts the scoring process to adapt to user feedback. One method to adjust message scoring based on user feedback is to adjust the weights of individual terms used by the analytics subsystem. In this case, when a message is scored by a user, the adaptive subsystem examines the content of the message and determines which terms on the termlist are present. If the score is too high, one or more of these terms could have their score decreased. Alternatively, if the score is too low, one or more terms could have their score increased. Further, if the user indicates that the score is correct, the adaptive subsystem could record this information and this could be used in future adjustments to determine which terms to adjust. For example, if a message is scored by a user as too high, and the adaptive subsystem finds two terms present in the message that are on a termlist, the adaptive subsystem could consider adjusting one or both of these terms. If one term has previously been marked as correct 10 times and the other marked as correct only once, the adjustment system could choose to adjust the term marked only once and leave the term marked 10 times unchanged.

Another method that could be utilized is to change the scoring model by adding or removing terms from a termlist. When a user scores a message, the adjustment system could examine the message content and find terms in the message that are in a termlist. The adjustment system could also identify terms that are not on (i.e., absent from) any termlist, and choose to add one or more of these terms to one or more termlists. In this respect the adjustment system could add new terms to a termlist. Alternatively, the adjustment system could determine to delete one or more terms from one or more termlists. This may be as simple as setting the weight for a term to zero, effectively eliminating the term from scoring consideration, marking it as deleted, or physically removing the term from one or more termlists.

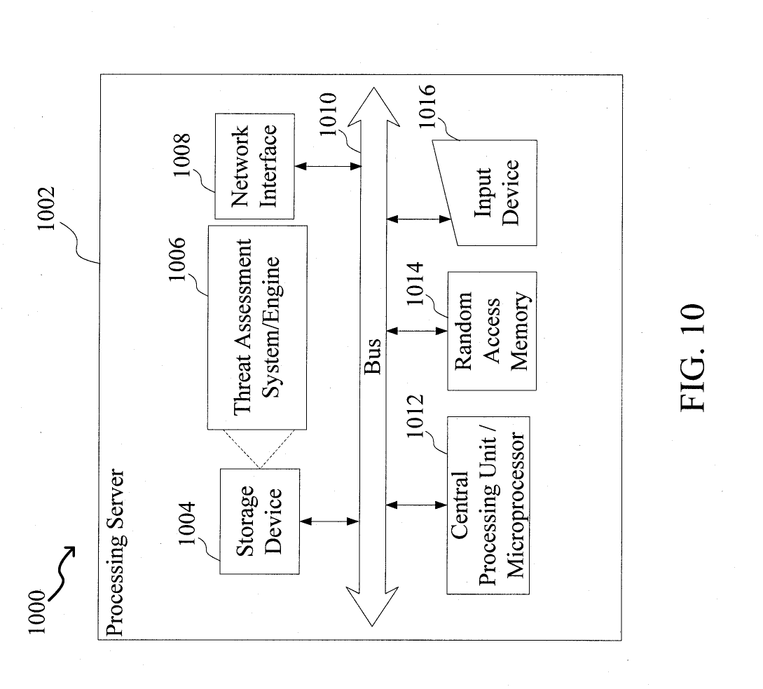

FIG. 10 is a diagram showing hardware and software components of a computer system 1000 capable of performing the processes discussed in FIGS. 1-9 above. The system 1000 (computer) comprises a processing server 1002 which could include a storage device 1004, a network interface 1008, a communications bus 1010, a central processing unit (CPU) (microprocessor) 1012, a random access memory (RAM) 1014, and one or more input devices 1016, such as a keyboard, mouse, etc. The server 1002 could also include a display (e.g., liquid crystal display (LCD), cathode ray tube (CRT), etc.). The storage device 1004 could comprise any suitable, computer-readable storage medium, such as disk, non-volatile memory (e.g., read-only memory (ROM), erasable programmable ROM (EPROM), electrically-erasable programmable ROM (EEPROM), flash memory, field-programmable gate array (FPGA), etc.). The server 1002 could be a networked computer system, a personal computer, a smart phone, etc.

The threat assessment system/engine 1006 could be embodied as computer-readable program code stored on the storage device 1004 and executed by the CPU 1012 using any suitable, high or low level computing language, such as Java, C, C++, C#, .NET, MATLAB, Python, etc. The network interface 1008 could include an Ethernet network interface device, a wireless network interface device, or any other suitable device which permits the server 1002 to communicate via the network. The CPU 1012 could include any suitable single- or multiple-core microprocessor of any suitable architecture that is capable of implementing and running the threat assessment engine 1006 (e.g., Intel processor). The random access memory 1014 could include any suitable, high-speed, random access memory typical of most modern computers, such as dynamic RAM (DRAM), etc.

It should be appreciated that the software systems discussed herein could be contained in separate components or could be combined together in different ways. The entire threat assessment system could be contained in a single software executable. Alternatively, one or more components could be contained in separate executables. Moreover, a single software component could be placed into multiple executables to enhance the performance of the system. In addition, there could be several instances of each component running in parallel to distribute the processing over several computer nodes.

In addition, the character set used is not limited to Roman characters, but could contain characters from any character element of any written language, and could utilize any suitable means of representing text. An example of the wide-variety of scripts could be found in the reference The Unicode 5.0 Standard, Addison-Wesley, October 2006, the entirety of which is incorporated herein by reference. It should be appreciated that the words, word groups, and terms described are not limited to working with English terms, but could be used in any language, or a combination of languages.

Having thus described the invention in detail, it is to be understood that the foregoing description is not intended to limit the spirit or scope thereof. Accordingly, although the present invention has been described with reference to particular embodiments thereof, it is understood by one of ordinary skill in the art, upon a reading and understanding of the foregoing disclosure, that numerous variations and alterations to the disclosed embodiments will fall within the spirit and scope of the present invention and of the appended claims.

What is claimed is:

1. A threat assessment system, comprising:
a computer system;
a data access subsystem programmed into and executed by the computer system for receiving data from a data source in communication with the computer system, and parsing the data to identify a message;
an analytics subsystem programmed into and executed by the computer system for processing and scoring the message to calculate one or more threat scores using one or more threat engines; and
a communications subsystem programmed into and executed by the computer system for determining whether to transmit the message and associated indication of threat level to a user based upon the one or more threat scores.

2. The threat assessment system of claim 1, wherein the message is of at least two languages.

3. The threat assessment system of claim 1, wherein the analytics subsystem determines hits based on one or more thresholds.

4. The threat assessment system of claim 3, wherein hits are determined from a multiscore metric dependent on one or more threshold combinations.

5. The threat assessment system of claim 1, further comprising an adaptive subsystem programmed into and executed by the computer system for allowing a user to provide feedback relating to the message.

6. The threat assessment system of claim 5, wherein the analytics subsystem includes a termlist comprising one or more terms and associated weights, and the adaptive subsystem adjusts the weights in the termlist based on user feedback.

7. The threat assessment system of claim 6, wherein the adaptive subsystem adds or deletes terms in the termlist based on user feedback.

8. The threat assessment system of claim 6, wherein the adaptive subsystem identifies terms that are not in the termlist.

9. The threat assessment system of claim 1, wherein the threat engine processes at least two messages in parallel.

10. The threat assessment system of claim 9, wherein the threat engine processes the at least two messages in parallel with at least one other threat engine.

11. The threat assessment system of claim 1, wherein the analytics subsystem scores the message using statistical language processing.

12. The threat assessment system of claim 1, wherein the analytics subsystem scores the message using natural language processing.

13. A method for threat assessment, comprising the steps of:
receiving data from a data source in communication with a computer system;
parsing the data to identify a message using a data access subsystem programmed into and executed by the computer system;
processing and scoring the message using an analytics subsystem programmed into and executed by the computer system to calculate one or more threat scores using one or more threat engines; and
determining whether to transmit the message to a user based upon the one or more threat scores using a communications subsystem programmed into and executed by the computer system.

14. The method for threat assessment of claim 13, wherein the message is of at least two languages.

15. The method for threat assessment of claim 13, further comprising determining hits based on one or more thresholds using the analytics subsystem.

16. The method for threat assessment of claim 15, wherein hits are determined from a multiscore metric dependent on one or more threshold combinations using the analytics subsystem.

17. The method for threat assessment of claim 13, further comprising allowing a user to provide feedback relating to the message using an adaptive subsystem programmed into and executed by the computer system.

18. The method for threat assessment of claim 17, wherein the analytics subsystem includes a termlist comprising one or more terms and associated weights, and further comprising adjusting the weights in the termlist based on user feedback.

19. The method for threat assessment of claim 18, further comprising adding or deleting terms in the termlist based on user feedback using the adaptive subsystem

20. The method for threat assessment of claim 18, further comprising identifying terms that are not in the termlist using the adaptive subsystem.

21. The method for threat assessment of claim 13, further comprising processing at least two messages in parallel using the threat engine of the analytics subsystem.

22. The method for threat assessment of claim 21, further comprising processing the at least two messages using the threat engine in parallel with at least one other threat engine.

23. The method for threat assessment of claim 13, wherein processing and scoring the message comprises statistical language processing.

24. The method for threat assessment of claim 13, wherein processing and scoring the message comprises natural language processing.

25. A computer-readable medium having computer-readable instructions stored thereon which, when executed by a computer system, cause the computer system to perform the steps of:
receiving data from a data source in communication with a computer system;
parsing the data to identify a message using a data access subsystem programmed into and executed by the computer system;
processing and scoring the message using an analytics subsystem programmed into and executed by the computer system to calculate one or more threat scores using one or more threat engines; and
determining whether to transmit the message to a user based upon the one or more threat scores using a communications subsystem programmed into and executed by the computer system.

26. The computer-readable medium of claim 25, wherein the message is of at least two languages.

27. The computer-readable medium of claim 25, further comprising determining hits based on one or more thresholds using the analytics subsystem.

28. The computer-readable medium of claim 37, wherein hits are determined from a multiscore metric dependent on one or more threshold combinations using the analytics subsystem.

29. The computer-readable medium of claim 25, further comprising allowing a user to provide feedback relating to the message using an adaptive subsystem programmed into and executed by the computer system.

30. The computer-readable medium of claim 29, wherein the analytics subsystem includes a termlist comprising one or more terms and associated weights, and further comprising adjusting the weights in the termlist based on user feedback.

31. The computer-readable medium of claim 30, further comprising adding or deleting terms in the termlist based on user feedback using the adaptive subsystem

32. The computer-readable medium of claim 30, further comprising identifying terms that are not in the termlist using the adaptive subsystem.

33. The computer-readable medium of claim 25, further comprising processing at least two messages in parallel using the threat engine of the analytics subsystem.

34. The computer-readable medium of claim 33, further comprising processing the at least two messages using the threat engine in parallel with at least one other threat engine.

35. The computer-readable medium of claim 25, wherein processing and scoring the message comprises statistical language processing.

36. The method for threat assessment of claim 25, wherein processing and scoring the message comprises natural language processing.
